(19) United States
(12) Patent Application Publication
(10) Pub. No.: US 2015/0164042 A1
(43) Pub. Date: Jun. 18, 2015

(54) PORTABLE PET TETHER

(71) Applicant: Bradley Moore, Pierre, SD (US)

(72) Inventor: Bradley Moore, Pierre, SD (US)

(21) Appl. No.: 14/104,162

(22) Filed: Dec. 12, 2013

(51) Int. Cl. A01K 1/04

(52) U.S. Cl. CPC A01K 1/04

(57) ABSTRACT

A portable pet tether that provides a mechanism to secure a pet in a stationary position. The portable pet tether is a dome-shaped device that is placed in a stationary position by driving stakes through anchors provided along the perimeter of the tether. The stakes or mounting nails are driven in the ground and therefore prevents the movement of the tether dome after placement. A clip is provided at the top of the dome in one particular embodiment that provides a means to secure the leash of a pet to the portable pet tether. In another particular embodiment, the portable pet tether includes a retractable leash that attaches directly to a pet's collar.

### BACKGROUND OF THE INVENTION

1. Field of Invention

The present invention relates to a portable pet tether that is capable of being secured in various locations to provide a portable means to tether a pet such as a dog.

2. Description of Related Art

Many people have various types of pets in particular of the four-legged variety. Pets such as a dog or at certain times a cat require a leash to control the movement of the pet while outdoors or in certain instances while being left unattended. A leash is normally used to control the movement of the pet. The leash is a tether or rope-type material that is normally attached to the neck of the pet. The pet usually has a collar or harness that is wrapped around the neck area that allows for the attachment of the leash. Leashes can vary in length and many times the leash may be handheld by the user or the leash may be attached to a stationary object to confine the movement of the pet that is attached to the leash. Some leashes vary in length due to the use of a spool and retraction mechanism, therefore providing flexibility in the length of the leash.

Many times a pet owner may be walking a pet and require that the pet remain outdoors and therefore must tether the pet to a stationary object while left unattended. Further it may be inconvenient to find an appropriate tree trunk or stake to tether the pet while left unattended. It would therefore be advantageous to have a device that may be used in a portable manner to tether a pet with the use of a conventional lease.

### SUMMARY OF THE INVENTION

The present invention relates to a portable pet tether that provides a mechanism to secure a pet in a stationary position. The portable pet tether is a dome-shaped device that is placed in a stationary position by driving stakes through anchors provided along the perimeter of the tether. The stakes or mounting nails are driven in the ground and therefore prevents the movement of the tether dome after placement. A clip is provided at the top of the dome in one particular embodiment that provides a means to secure the leash of a pet to the portable pet tether. In another particular embodiment, the portable pet tether includes a retractable leash that attaches directly to a pet's collar.

### BRIEF DESCRIPTION OF DRAWINGS

FIG. 1 depicts a top view of a portable pet tether in accordance with the present invention.

FIG. 2 depicts a side view of the pet tether in accordance with the present invention.

FIG. 3 depicts a top view of an alternative embodiment of a portable pet tether in accordance with the present invention.

### DETAILED DESCRIPTION

The present invention relates to a portable pet tether that provides a means to tether a pet. The portable pet tether may be mounted into the ground with the use of mounting nails and through anchors provided on the perimeter of the pet tether. In one particular embodiment, the pet tether is a circular dome that has anchors that extend from the perimeter thereof. Ideally three anchors are equally spaced around the circular perimeter of the tether. Each anchor includes a hole that allows the insertion of a mounting nail that is driven into the ground surface. Once driven into the ground surface the tether is stabilized and anchored for use. Further a driving stake is provided at the center of the bottom surface of the tether dome. The center stake helps to stabilize and maintain a stationary position on the tether dome.

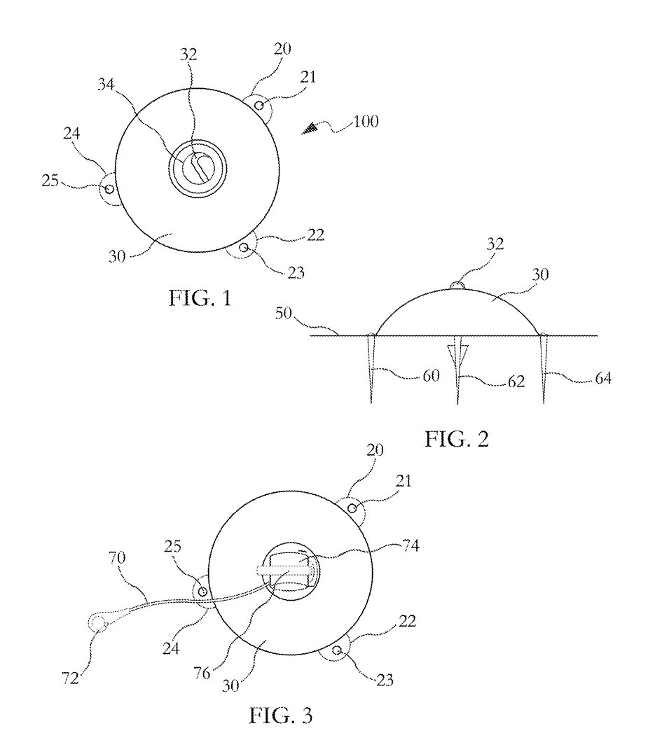

In reference to FIG. 1, a top view of a portable pet tether 100 is depicted. The portable pet tether 100 includes a dome surface 30 with anchors 20, 22, 24 equally spaced along the outside perimeter of the dome 30. Each anchor includes an opening 21, 23, 25 that enables the insertion of the mounting nails into the anchors 20, 22, 24. At the top of the dome, a clip ring 32 is provided. The clip ring 32 allows for the user to attach a leash to the dome 30 and allow for the attachment to the pet tether 100 once it is mounted in a stationary position. Bearings 34 surround the clip ring 32 that allows for the clip ring 32 to swivel in a circular motion at the top surface of the dome 30. A side sectional view of the dome 30 is depicted in FIG. 2. The side view shows mounting nails 60, 64. These nails are driven through one of the openings provided in the anchors 20, 22 or 24. At the center of the dome is a stake 62. The stake 62 includes flange spikes around the outside perimeter to firmly mount the pet tether 100 into a stationary position. The stake 62 and nails 60, 64 are shown below a ground surface 50.

In reference to FIG. 3, an alternative embodiment of the pet tether 100 is depicted. In this alternative embodiment the clip ring 32 is removed and replaced with a retractable leash 70. The leash 70 is maintained on a spool 74 and extends at varied length for use with a dog or pet collar. A hook attachment 72 attaches to the pet collar and consequently the leash 70 extends at a predetermined length based upon the desired design. A latch 76 keeps the spool 74 in place while the leash extends outwardly from the spool 74.

This portable pet tether in accordance with the present invention provides an effective means to tether a pet in various situations where there isn't an existing means to accomplish such. The foregoing descriptions of specific embodiments of the present invention have been presented for purposes of illustration and description. They are not intended to be exhaustive or to limit the invention to the precise forms disclosed, and obviously many modifications and variation are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A portable pet tether comprising:
a. a dome surface
b. at least three anchors equally spaced along an outside perimeter of the dome;
c. an opening within each anchor, where the opening enables the insertion of a mounting nail;
d. a clip ring at the top of the dome, where the clip ring allows for the user to attach a leash to the dome and is placed flush to accommodate the retractable leash; and
e. a stake extending from a bottom surface of the dome.

2. The portable pet tether according to claim 1, further including bearings surrounding the clip ring, where the bearings the clip ring to swivel in a circular motion.

3. The portable pet tether according to claim 1, where the stake includes flange spikes around the outside perimeter of the stake.

4. A portable pet tether comprising:
a. a dome surface
b. at least three anchors equally spaced along an outside perimeter of the dome;
c. an opening within each anchor, where the opening enables the insertion of a mounting nail;
d. a retractable leash positioned on top of the dome, where the leash is maintained on a spool;
e. a clip ring at the top of the dome, where the clip ring allows for the user to attach a leash to the dome; and
f. a stake extending from a bottom surface of the dome.

5. The portable pet tether according to claim 4, further including a latch, where the latch keeps the spool in place.

6. The portable pet tether according to claim 4, further including a hook attachment at an end of the retractable leash.

7. The portable pet tether according to claim 1, where the stake includes flange spikes around the outside perimeter of the stake.
